(19) United States
(12) Patent Application Publication
(10) Pub. No.: US 2015/0071718 A1
(43) Pub. Date: Mar. 12, 2015

(54) METHOD TO PRODUCE A RADIAL RUN-OUT TOOL AS WELL AS A RADIAL RUN-OUT TOOL

(71) Applicant: Kennametal Inc., Latrobe, PA (US)

(72) Inventor: Herbert Rudolf KAUPER, Erlangen (DE)

(21) Appl. No.: 14/479,831

(22) Filed: Sep. 8, 2014

(30) Foreign Application Priority Data
Sep. 12, 2013 (DE) 102013218321.6

(51) Int. Cl. B24B 3/24; B23C 5/10; B24B 3/06; B23B 51/02

(52) U.S. Cl. CPC B24B 3/242; B23B 51/02; B23C 5/10; B24B 3/06; B23B 2251/406; B23C 2210/40
USPC 407/54; 451/48; 408/219

(57) ABSTRACT

The radial run-out tool (2), particularly a drill or a cutter, has a basic body (12) extending in an axial direction (4) and comprises at least two chip grooves (14), to which a guide chamfer (22) is connected in the rotational direction (24), with a ridge (15) being formed between them. A radial clearance is connected to the guide chamfer (22). In order to enable simple and economical production of such type of radial run-out tool (2), an unprocessed rod (30) is ground non-concentrically, in a first process step, such that a radius (R) of the unprocessed rod (30) varies, depending on the angle, between a maximum radius (R2) and a minimum radius (R1). In a second process step, the chip grooves (14) are grounded down such that the guide chamfers (22) are formed at the positions with the maximum radius (R2) and the radius (R) is subsequently reduced downstream of the respective guide chamfer (22) in order to form the radial clearance (28).

### RELATED APPLICATION DATA

The present application claims priority under 35 U.S.C §119(a) to German Patent Application Number 102013218321.6 filed Sep. 12, 2013 which is incorporated herein by reference in its entirety.

### BACKGROUND

The invention relates to a method for producing a radial run-out tool, particularly drill or a cutter, comprising a basic body extending in the axial direction, with the basic body having at least two chip grooves as well as a guide chamfer connected to each of the chip grooves, in which a ridge is formed between each of the chip grooves and a radial clearance in the ridge is connected to the guide chamfer, said clearance extending up to the following chip groove. The invention further relates to such type of radial run-out tool, particularly a drill or cutter.

EP 1 334 787 B1 discloses such type of radial run-out tool as a drilling tool. The known drill is a solid metal drill with a cutting area connecting to a clamp shaft, with the cutting area housing spiraled chip grooves, which extend up to a drill face. Secondary cutting areas extend along the spiral chip groove, and a guide chamfer is connected to each of the secondary cutting areas in the rotational direction; during operation, the guide chamfer is supported on the inner wall of the borehole and thus ensures guidance for the drill.

Such types of solid metal drills are typically produced from a unmachined rod by grinding, in which, in a first process step, the unmachined rod is ground down to a desired nominal ground diameter; in a second process step, the optionally spiraled chip grooves are ground; and finally, and in a third process step, the ridge is ground in order to create radial clearance so that the ridge is some distance away from the borehole wall during the actual drilling process. In addition to this, typically additional grinding steps are provided to generate the desired tip geometry of the drill tip. The three process steps characterized serve to form the cutting area of the radial run-out tool in the axial direction downstream of the drill tip.

### SUMMARY

Starting from this point, the object of the invention was to provide a simplified manufacturing method for such type of radial run-out tool as well as such type of radial run-out tool that is easy to produce.

The object is achieved according to the invention by a method with the features of claim 1 as well as by a radial run-out tool with the features of claim 6. Preferred further embodiments are contained in the respective dependent claims.

The radial run-out tool generally extends in the axial direction and is particularly made of solid metal, particularly a solid carbide drill. It has a basic body, in which at least two chip grooves are housed, and a guide chamfer is connected to each of the chip grooves on the circumferential side of the basic body, when it is viewed in the circumferential or rotational direction. A ridge is formed between each of two consecutively positioned chip grooves, and a radial clearance is located in said ridge downstream of the respective guide chamfer.

For simplified production of such type of radial run-out tool, particularly a drill or a cutter, it is now provided, in a first process step, for an unmachined rod to be non-concentrically ground such that a radius of the unmachined rod and thus of the basic body varies, depending on the angle, between a maximum radius and a minimum radius. In a second process step, the chip grooves are ground down. All in all, the unmachined rod is ground such that the guide chambers are inevitably formed at the positions with the maximum radius and the radial clearance is likewise inevitably formed based on the non-concentric design. The clearance extends in this case starting from the guided chamfer to the next chip groove. Therefore, during operation, there is a radial clearance between the ridge and an inner wall of a machined workpiece.

The particular advantage of this manufacturing method can be seen in that the third grinding step is not required and, in particular, also not intended. Rather, the radial clearance is automatically formed based on the non-concentric cross-sectional geometry. Thus, one manufacturing step as a whole is saved, which leads to cost savings and time savings.

The machining of a cutting area following a tool tip thus requires merely the two mentioned process steps; additional grinding steps are not provided for. The two process steps may be carried out essentially in any sequence. It is preferable, however, if the unmachined rod is initially ground non-concentrically before the chip grooves are ground down.

In a preferred embodiment, the unmachined rod is ground down, in a first process step, to an elliptical cross-sectional surface. It is generally understood in this case that the basic body tapers continually from the maximum radius to the minimum radius and then continually increases up to a second opposing maximum radius. With this design variant, there are thus exactly two chip grooves, each of which having a guide chamfer. Essentially, the method described here can be transferred to a plurality of geometries, for example those with three or four chip grooves. What is essential in this case is that the radius tapers continually and constantly starting from the maximum radius to the minimum radius. The ridge extends in this case generally along a thoroughly curved, bend- and recess-free circumferential line. Connecting directly to the guide chamfer, the radial clearance increases continuously. The guide chamfer itself thus does not have a uniform radius, as is the case with conventional circular grinding chamfers. Instead, the guide chamfer itself has a relief grind and linear-shaped contact, only when in use and when viewed in the axial direction, with a workpiece wall.

According to the elliptical configuration, the minimum radius defines therefore also preferably a small half-axis and a maximum radius defines a large half-axis of the elliptical cross-sectional surface. Thus, it is appropriately provided that the minimum radius is in a range of from 0.75 to 0.98 times, and particularly in a range of from 0.92 to 0.95 times, the maximum radius. This enables sufficient clearance to be achieved on one side and a sufficient support to be achieved in the area of the guide chamfer on the other side. Due to the comparatively minor differences in the two radii, the radius at the guide chamfer is reduced only moderately, which means that a sufficient guide function is ensured.

In an appropriate further embodiment, the chip grooves in this case are ground down to extend in a spiral. Correspondingly, the guide chamfers are thus also formed to extend in a spiral. In order to ensure that the guide chamfers are formed at the positions with the maximum radius over the entire cutting area defined by the chip grooves and beyond, when viewed in the rotational direction, the elliptical cross-sectional surface is also formed to extend in a spiral. In this case, it is understood that the maximum radius extends along a spiral line, when viewed in the axial direction. This spiral line is identical to the pattern of the respective guide chamfer in this case. Alternatively, the chip grooves extend in a straight line.

In order to produce this non-concentric pattern, a grinding disc is placed in the radial direction toward the next round unmachined rod. The unmachined rod in this case rotates around its center axis. Depending on the angle position, the radial feed position of the grinding disc will then vary such that different radii will form on the unmachined rod depending on the angle. In addition, the radial feed position of the grinding disc will vary, also depending on the axial position of the grinding disc, thus resulting in the desired spiral pattern of the elliptical cross-sectional surface, so that the maximum radius of the ellipse extends in a respective cutting plane along a spiral line.

The radial-run out tool is, in particular, a solid carbide drill with a pointy grind. Depending on the requirements and the application purpose, the basic body will have one or more coolant holes, depending on the application area, and is additionally preferably slightly conically tapered starting from the tool tip to a shaft area.

### BRIEF DESCRIPTION OF THE DRAWINGS

An exemplary embodiment of the invention is explained in more detail in the following by means of the figures. The figures show the following in simplified representations:

FIG. 1A a side view of a solid carbide drill with spiral chip grooves according to the prior art;

FIG. 1B a front view of a tool tip of the spiral drill shown in FIG. 1A;

FIG. 2A a diagrammed cross-sectional representation of the proportions of such type of drill according to the prior art in the area of a guide chamfer;

FIG. 2B an enlarged representation of the area shown with a circle in FIG. 2A;

FIG. 3A a diagrammed cross-sectional representation of the proportions of a drill according to the invention in the area of the guide chamfer;

FIG. 3B an enlarged representation of the area shown with a circle in FIG. 3A;

FIG. 4 a perspective representation of a non-concentrically ground unmachined rod, which has an elliptical cross-sectional surface that extends in a spiral in the axial direction;

FIG. 5A a view of front cutting plane A-A in FIG. 4; as well as

FIG. 5B a view of cutting plane B-B in FIG. 4.

Parts having the same effect, having the same reference numbers, are also in the figures.

### DETAILED DESCRIPTION

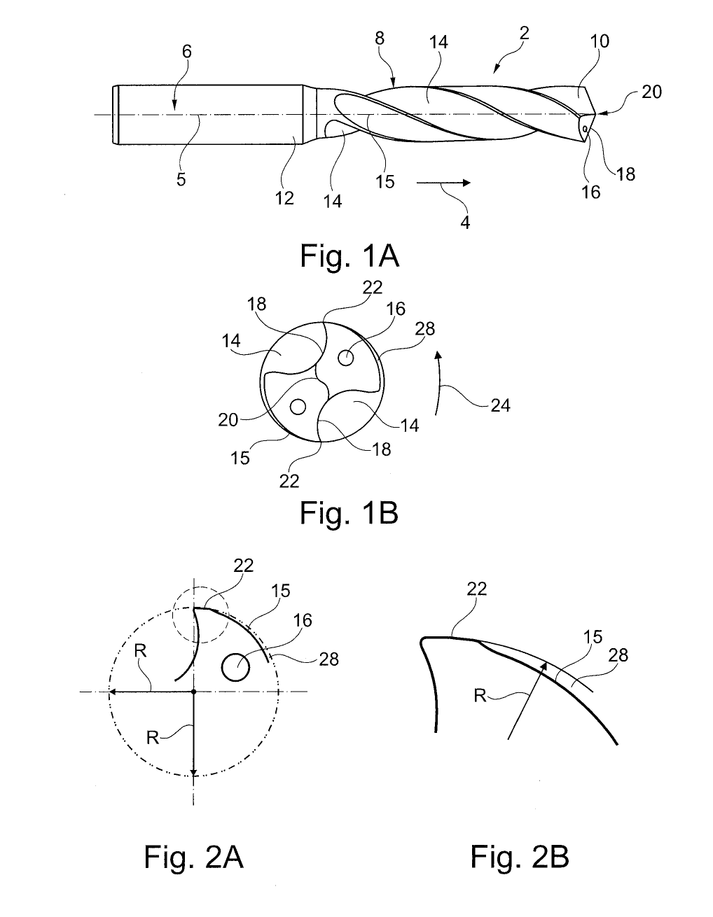

The solid metal drill 2 shown in FIG. 1A is formed as a spiral drill and extends in the axial direction 4 along a center longitudinal axis 5, which simultaneously also defines a rotational axis. In the rear area, the drill 2 has a clamp shaft 6, to which a grooved cutting area 8 is connected, which extends to a front-facing tool tip 10. The drill 2 in this case, as a whole, has a solid carbide basic body 12, in which chip grooves 14 are ground in the cutting area 8, with a ridge 15 being formed between each of the cutting grooves. In addition, the basic body 12 has coolant channels 16.

In the exemplary embodiment, the tool tip 10 is ground in the shape of a cone and has two main cutting areas 18, which are connected to one another via a cross-cutting area. The main cutting areas 18 extend to a radial cutting corner on the outside, to which a secondary cutting area is connected with a guide chamfer 22 formed on the ridge 15 along the respective chip groove 14 extending in the axial direction 4. During operation, the drill 2 rotates in the rotational direction 24 around its center longitudinal axis 5. With conventional drills, the guide chamfer 22 is typically formed as a so-called circular grinding chamber; that is, it does not have any radial relief grind and thus no clearance. Therefore, the radius is constant over the entire angle of rotation of the guide chamfer and typically corresponds to a nominal radius to which the unmachined rod is concentrically ground down, in a first process step, with a conventional manufacturing method.

A radial clearance 28 is housed in the ridge 15 downstream of the respective guide chamfer 22, when viewed in the rotational direction 24. With the conventional manufacturing method, this occurs in a third separate grinding step, after the chip grooves 14 have been placed previously in a second grinding step.
These conventional conditions have been diagrammed again for further clarification in FIGS. 2A and 2B for the prior art. The dash/dotted circle in FIG. 2A shows a circular circumferential line 31, with a constant radius R. As can be clearly seen again from the representation according to FIG. 2B, the guide chamfer 22 extends initially precisely on this circular arc line, which results after the first cylindrical grinding step with the conventional method.

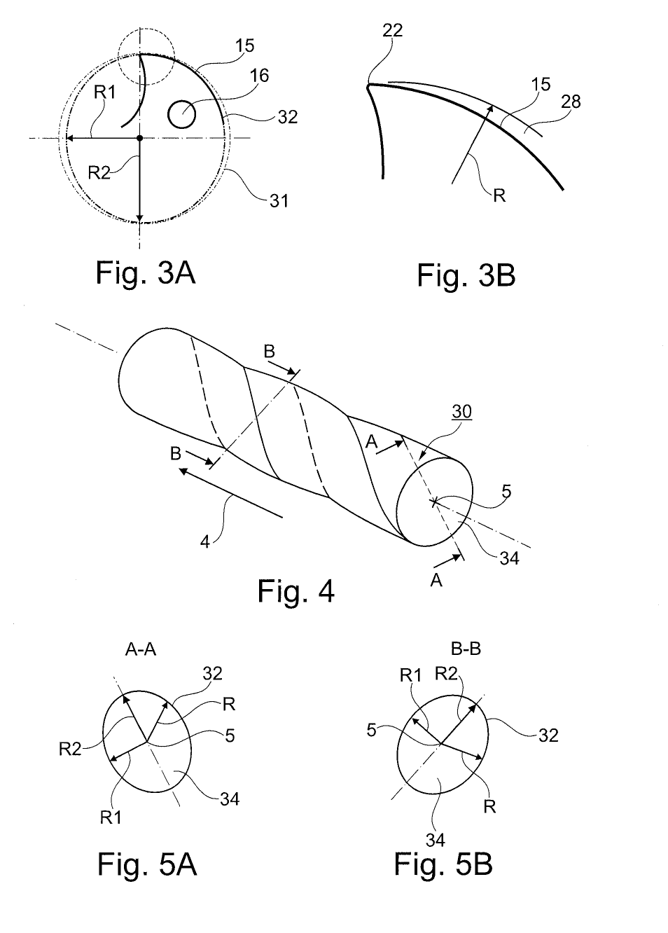

An exemplary embodiment of the invention will now be explained in greater detail using FIGS. 3A, 3B, 4, 5A, and 5B.

Basically, an unmachined rod 30 is non-concentrically ground, in a first process step, so that an elliptical circumferential line 32 is formed in a respective cross-section of the rod 30. Accordingly, the radius R varies, that is the distance from the center longitudinal axis 5 to the circumferential side, from a minimum radius R1 to a maximum radius R2.

The variation in this case is continual and constant—as is customary with an elliptical cross-section.

The deviation of the elliptical circumferential line 32 from the circular circumferential line 31 as results after cylindrical grinding with the prior art can be seen in FIG. 3A. As can be particularly seen from the enlarged representation of FIG. 3B, the radius R along the ridge 15 reduces itself continually from the maximum radius R2, which defines a nominal radius and simultaneously specifies the position of the guide chamfer 22, down to the minimum radius R1. Depending on how the respective chip groove 14 is formed, that is depending on the angle range over which the chip groove extends, the radius R will continually decrease with respect to the chip groove 14 or it will increase with respect to the chip groove 14. However, this will not be to the point of the maximum radius R2, so that there is assurance that the radial clearance 28 is retained and the ridge 15 will be a certain distance from an interior wall of the workpiece when in use.

As is particularly clear from FIG. 4 in conjunction with FIGS. 5A and 5B, the unmachined rod 30 serves to form a spiral grooved spiral drill 2. Accordingly, an elliptical cross-sectional surface 34 of the ground unmachined rod 30 rotates continuously in the axial direction 4 around the center longitudinal axis 5, so that the maximum radius R2 or the minimum radius R1, when viewed in the axial direction 4, extends along spiral lines, as this is shown for minimum radius R1 by a solid line and for maximum radius R2 by a dotted line in FIG. 4.

1. A method to produce a radial run-out tool, particularly of a drill (2) or of a cutter, comprising a basic body (12) extending in the axial direction (4), having
at least two chip grooves (14)
guide chamfers (22), which extend along each of the chip grooves (14)
a ridge (15) between each of the chip grooves (14)
a radial clearance (28), connected to the respective guide chamfer (22), in the ridge (15), which extends to the next chip groove (14)
characterized in that
in a first process step, an unprocessed rod (30) is ground non-concentrically, such that a radius (R) of the unprocessed rod (30) varies, depending on the angle, between a maximum radius (R2) and a minimum radius (R1) and that
in a second process step, the chip grooves (14) are ground in such that the guide chamfers (22) are formed at the positions with the maximum radius (R2) and the radius (R) is subsequently reduced in the rotational direction (24) with respect to the respective guide chamfer (22) in order to form the radial clearance (28) due to the non-concentric design.

2. The method according to claim 1,
characterized in that
the unprocessed rod (30) is ground, in a first process step, down to an elliptical cross-sectional surface (34).

3. The method according to claim 2,
characterized in that
the minimum radius (R1) defines a small half-axis and the maximum radius (R2) defines a large half-axis of the elliptical cross-sectional surface (34).

4. The method according to claim 1,
characterized in that
the minimum radius (R1) is in a range of 0.75 to 0.98 times, or particularly in a range of 0.92 to 0.95 times, the maximum radius (R2).

5. The method according to claim 1,
characterized in that
the chip grooves (14) are ground into the shape of a spiral and the guide chamfers (22) extend in the shape of a spiral along the maximum radius (R2).

6. A radial run-out tool, particularly a drill (2) or cutter, comprising a basic body (12) extending in the axial direction (4), wherein the basic body (12) has
at least two chip grooves (14)
a guide chamfer (22) connected to each chip groove (14) in a rotational direction (24)
a ridge (15) between each of the chip grooves (14)
a radial clearance (28), connected to the guide chamfer (22) in the rotational direction (24), in the ridge (15), which extends to the next chip groove (14),
characterized in that
a radius (R) of the basic body (12) tapers directly following the guide chamfer (22) and a radial clearance (28) is formed before the following chip groove (14).

7. The radial run-out tool according to claim 6,
characterized in that
the ridge (15) extends along an elliptical circumferential line (32) when viewed cross-sectionally.

8. The radial run-out tool according to claim 6,
characterized in that
the chip grooves (14) extend in the axial direction (4) and define a cutting area (8), wherein an elliptical cross-sectional surface (34) is formed in the entire cutting area (8).

9. The radial run-out tool according to claim 6,
characterized in that
the chip grooves (14) are spiraled in the axial direction (4).
